(19) United States
(12) Patent Application Publication
(10) Pub. No.: US 2024/0326466 A1
(43) Pub. Date: Oct. 3, 2024

(54) RECORDING DEVICE

(71) Applicant: SEIKO EPSON CORPORATION, Tokyo (JP)

(72) Inventors: Takashi GOKUDEN, AZUMINO-SHI (JP); Hiroki NISHIOKA, SUWA-SHI (JP)

(73) Assignee: SEIKO EPSON CORPORATION, Tokyo (JP)

(21) Appl. No.: 18/616,088

(22) Filed: Mar. 25, 2024

(30) Foreign Application Priority Data
Mar. 28, 2023 (JP) 2023-051150

(51) Int. Cl. B41J 2/455

(52) U.S. Cl. CPC B41J 2/455

(57) ABSTRACT

A recording device includes a laser element configured to emit laser light, a light reception element, a moving mechanism configured to change a relative position of the laser element and a recording target object and a relative position of the laser element and the light reception element, and a control unit configured to control the laser element and the moving mechanism. The control unit performs a first process of controlling the laser element and the moving mechanism to irradiate the light reception element with laser light in a state where the laser element and the light reception element face each other, and a second process of controlling the laser element and the moving mechanism to irradiate the recording target object with laser light based on a detection value of the light reception element in a state where the laser element and the recording target object face each other.

The present application is based on, and claims priority from JP Application Serial Number 2023-051150, filed Mar. 28, 2023, the disclosure of which is hereby incorporated by reference herein in its entirety.

### BACKGROUND

### 1. Technical Field

The present disclosure relates to a recording device.

### 2. Related Art

There has been known a recording device that performs recording such as printing on a recording target object through irradiation with laser light.

For example, JP-A-2001-150724 describes a printer device including an optical printer head that includes a surface emitting-type semiconductor laser array and a fiber optical plate. In the optical printer head, the fiber optical plate is installed to face a laser light emitting surface of the surface emitting-type semiconductor laser array.

With the above-mentioned recording device, characteristics of a laser element are deviated from the designed value in some situation when recording on a recording target object is repeatedly performed. Recording cannot be accurately performed when recording is performed in a state where the characteristics of the laser element are deviated from the designed value.

### SUMMARY

An aspect of a recording device according to the present disclosure includes a laser element configured to emit laser light, a light reception element configured to receive the laser light from the laser element, a moving mechanism configured to change a relative position of the laser element and a recording target object and a relative position of the laser element and the light reception element, and a control unit configured to control the laser element and the moving mechanism, wherein the control unit is configured to perform a first process of controlling the laser element and the moving mechanism to irradiate the light reception element with laser light in a state where the laser element and the light reception element face each other, and a second process of controlling the laser element and the moving mechanism to irradiate the recording target object with laser light based on a detection value of the light reception element in a state where the laser element and the recording target object face each other.

### BRIEF DESCRIPTION OF THE DRAWINGS

FIG. 1 is a perspective view schematically illustrating a recording device according to the present embodiment.

FIG. 2 is a perspective view schematically illustrating the recording device according to the present embodiment.

FIG. 3 is a bottom view schematically illustrating a head of the recording device according to the present embodiment.

FIG. 4 is a cross-sectional view schematically illustrating the recording device according to the present embodiment.

FIG. 5 is a cross-sectional view schematically illustrating the recording device according to the present embodiment.

FIG. 6 is a cross-sectional view schematically illustrating the recording device according to the present embodiment.

FIG. 7 is a cross-sectional view schematically illustrating the recording device according to the present embodiment.

FIG. 8 is a cross-sectional view schematically illustrating the recording device according to the present embodiment.

FIG. 9 is a flowchart for describing a process of a control unit of the recording device according to the present embodiment.

FIG. 10 is a graph illustrating a relationship between a time and a light output at a laser element of the recording device according to the present embodiment.

FIG. 11 is a graph illustrating a relationship between an injected current and a light output at the laser element of the recording device according to the present embodiment.

FIG. 12 is a graph illustrating a relationship between the injected current and the light output at the laser element of the recording device according to the present embodiment.

FIG. 13 is a perspective view schematically illustrating a recording device according to a first modification of the present embodiment.

FIG. 14 is a cross-sectional view schematically illustrating the recording device according to the first modification example of the present embodiment.

FIG. 15 is a perspective view schematically illustrating a recording device according to a second modification example of the present embodiment.

FIG. 16 is a cross-sectional view schematically illustrating the recording device according to the second modification example of the present embodiment.

FIG. 17 is a perspective view schematically illustrating the recording device according to the second modification example of the present embodiment.

FIG. 18 is a perspective view schematically illustrating the recording device according to the second modification example of the present embodiment.

FIG. 19 is a perspective view schematically illustrating a recording device according to a third modification example of the present embodiment.

FIG. 20 is a perspective view schematically illustrating the recording device according to the third modification example of the present embodiment.

### DESCRIPTION OF EMBODIMENTS

A preferred embodiment of the present disclosure is described in detail below with reference to the drawings. Note that the present embodiment described below do not unduly limit the content of the present disclosure described in the claims. In addition, not all the configurations described below are essential constituent elements of the present disclosure.

### 1. Recording Device

### 1.1. Configuration

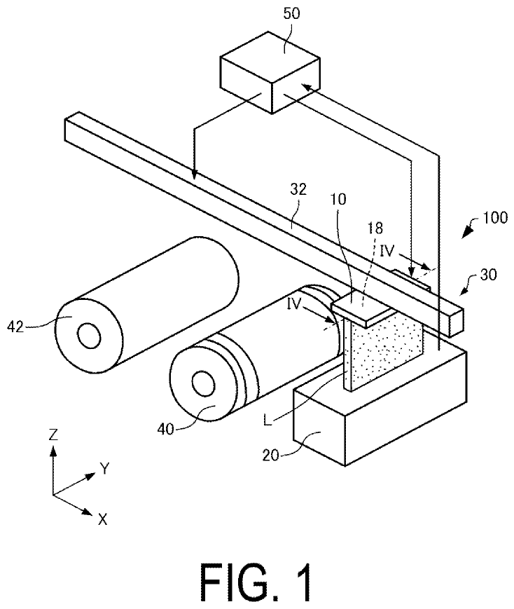

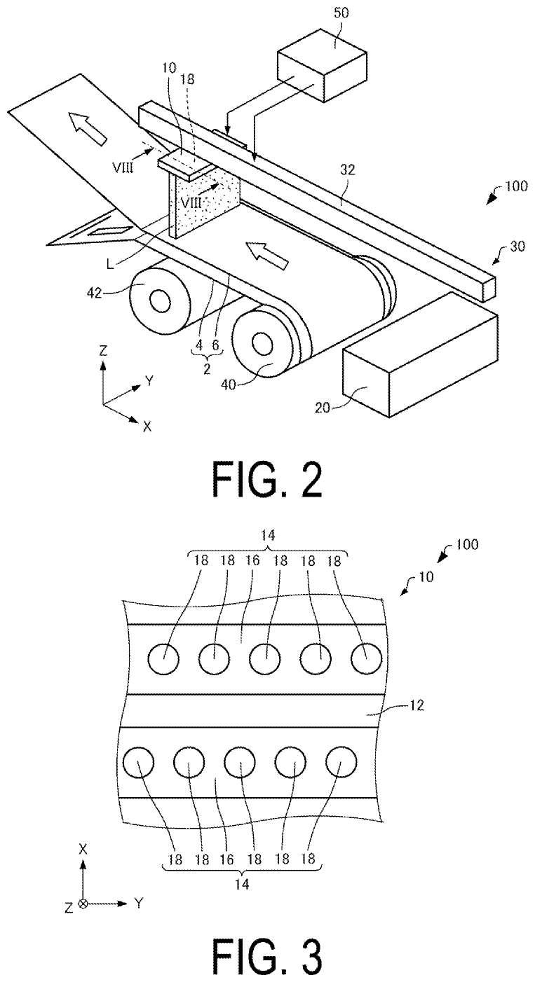

First, a recording device according to the present embodiment is described with reference to the drawings. FIG. 1 and FIG. 2 are perspective views schematically illustrating a recording device 100 according to the present embodiment. In addition, in FIG. 1 and FIG. 2, an X axis, a Y axis, and a Z axis as three axes orthogonal to each other are illustrated. The X-axis direction and the Y-axis direction are horizontal directions, for example. The Z-axis direction is a vertical direction, for example.

As illustrated in FIG. 1 and FIG. 2, for example, the recording device 100 includes a head 10, a light reception element 20, a moving mechanism 30, a transport unit 40, a support unit 42, and a control unit 50. Note that FIG. 1 illustrates a state where the head 10 and the light reception element 20 face each other. FIG. 2 illustrates a state where the head 10 and a recording target object 2 face each other.

The head 10 emits laser light L. In the example illustrated in the drawing, the head 10 emits the laser light L in the −Z-axis direction. Here, FIG. 3 is a bottom view schematically illustrating the head 10.

As illustrated in FIG. 3, the head 10 includes a first substrate 12 and a laser element array 14, for example. The first substrate 12 supports the laser element array 14. The material of the first substrate 12 is not particularly limited.

The laser element array 14 is provided in the first substrate 12. In the example illustrated in the drawing, the laser element array 14 has a shape extended in the Y-axis direction. A plurality of the laser element arrays 14 are provided, for example. The number of the laser element arrays 14 is not particularly limited. In the example illustrated in the drawing, two laser element arrays 14 are provided. The two laser element arrays 14 are arranged in the X-axis direction.

The laser element array 14 includes a second substrate 16 and a laser element 18, for example. The second substrate 16 is provided in the first substrate 12. The material of the second substrate 16 is not particularly limited.

The laser element 18 is provided in the second substrate 16. The laser element 18 emits the laser light L. In the example illustrated in the drawing, the shape of the laser element 18 is a circular shape in plan view as viewed in the Z-axis direction. For example, the laser element 18 is a surface emitting laser. Specifically, the laser element 18 is a Photonic Crystal Surface Emitting Laser (PCSEL) using a photonic crystal effect. The laser light L emitted from the laser element 18 being a PCSEL has a small radiation angle and a high light output. Note that the laser element 18 may be a Vertical Cavity Surface Emitting Laser (VCSEL). Further, the shape of the laser element 18 may be a polygonal shape such as a square shape, a rectangular shape, and a hexagonal shape in plan view as viewed in the Z-axis direction.

A plurality of the laser elements 18 are provided in one laser element array 14. In the example illustrated in the drawing, the plurality of laser elements 18 are arranged in the Y-axis direction in one laser element array 14. For example, the head 10 is a line head that is not displaced in the Y-axis direction at the time of recording on the recording target object 2. In this manner, the recording time on the recording target object 2 can be reduced. In the laser element arrays 14 adjacent to each other in the X-axis direction, the laser elements 18 are displaced in the Y-axis direction. In other words, in the laser element arrays 14 adjacent to each other in the X-axis direction, the center of the laser element 18 in one laser element array 14 and the center of the laser element 18 in the other laser element array 14 do not overlap with each other as viewed from the X-axis direction. In this manner, a resolution of recording on the recording target object 2 can be improved. Note that recording includes printing and image rendering.

As illustrated in FIG. 1, the laser light L emitted from the laser element 18 is incident on the light reception element 20. The light reception element 20 is irradiated with the laser light L from the laser element 18. The light reception element 20 receives the laser light L from the laser element 18 and detects the intensity of the received laser light L. The detection value of the light reception element 20 is transmitted to the control unit 50. The light reception element 20 includes a photodiode, for example. The light reception element 20 is a laser power meter, or a laser energy meter, for example.

Note that the light reception element 20 may be an imaging element such as a Charge Coupled Device (CCD) image sensor and a Complementary Metal Oxide Semiconductor (CMOS) image sensor. In this case, the light reception element 20 can detect the two-dimensional intensity distribution of the emission from the plurality of laser elements 18.

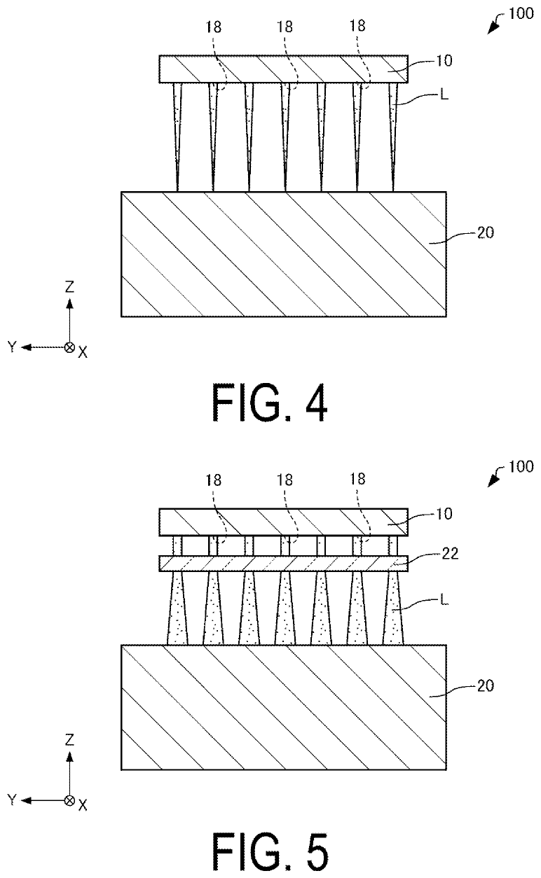

Here, FIG. 4 is a sectional view taken along the line IV-IV in FIG. 1, schematically illustrating the recording device 100. When an output of the laser light L is lower than a predetermined value, the laser light L may be incident directly on the light reception element 20 from the laser element 18 as illustrated in FIG. 4.

Meanwhile, when an output of the laser light L is higher than the predetermined value, the laser light L may be incident on the light reception element 20 via an optical element 22 as illustrated in FIG. 5. The optical element 22 is provided between the head 10 and the light reception element 20. For example, the optical element 22 is a diffusion element that diffuses the laser light L from the laser element 18. In this manner, density of the laser light L incident on the light reception element 20 can be reduced. As a result, damage to the light reception element 20 due to the laser light L can be suppressed. For the optical element 22, a glass diffusion plate is used, for example. In the example illustrated in the drawing, the optical element 22 causes the laser light L from the laser elements 18 adjacent to each other in the Y-axis direction to be incident on the light reception element 20 in a non-superimposed state.

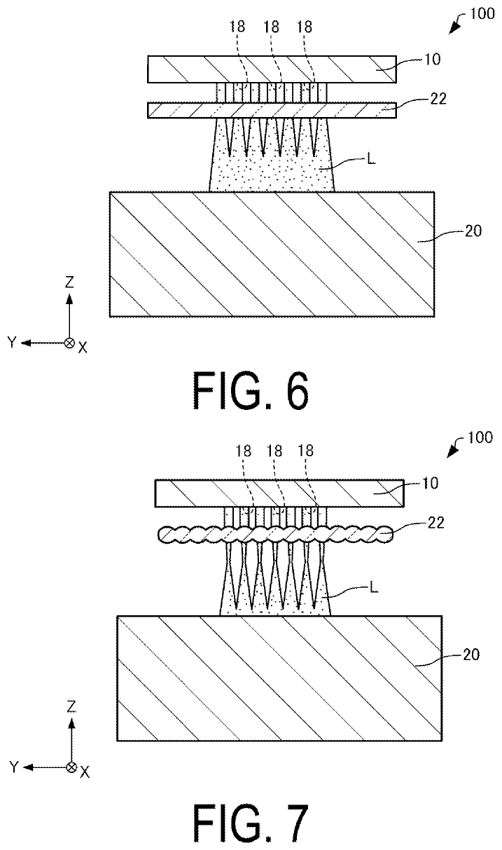

Note that the optical element 22 may cause the laser light L emitted from the laser elements 18 adjacent to each other in the Y-axis direction to be incident on the light reception element 20 in a superimposed state as illustrated in FIG. 6.

In addition, the optical element 22 is not limited to the glass diffusion plate as long as the laser light L can be diffused. As illustrated in FIG. 7, the optical element 22 may be a lens array. In this case, preferably, the focal point of the lens making up the optical element 22 is not located on the light reception element 20. In this manner, damage to the light reception element 20 due to the laser light L can be suppressed. A plurality of the lenses forming the optical element 22 are provided in a manner corresponding to the number laser elements 18, for example.

Further, the optical element 22 may be a light reduction element that reduces the laser light L from the laser element 18.

For example, the distance between the light reception element 20 and the head 10 in a state where the light reception element 20 and the head 10 face each other may be larger than the distance between the recording target object 2 and the head 10 in a state where the recording target object 2 and the head 10 face each other. In this manner, damage to the light reception element 20 due to the laser light L can be suppressed.

As illustrated in FIG. 1 and FIG. 2, the moving mechanism 30 supports the head 10. The moving mechanism 30 changes the relative position of the head 10 and the recording target object 2 and the relative position of the head 10 and the light reception element 20. In other words, the moving mechanism 30 changes the relative position of the laser element 18 and the recording target object 2 and the relative position of the laser element 18 and the light reception element 20. For example, the moving mechanism 30 moves the laser element 18 to change the relative position of the laser element 18 and the recording target object 2 and the relative position of the laser element 18 and the light reception element 20. In the example illustrated in the drawing, the moving mechanism 30 moves the head 10 in the X-axis direction. The moving mechanism 30 does not move the head 10 in the Y-axis direction, for example. For example, the moving mechanism 30 does not move the light reception element 20 and the recording target object 2.

For example, the moving mechanism 30 includes a guide rail 32, and a motor and an encoder, which are omitted in illustration. The guide rail 32 has a shape extended in the X-axis direction, for example. The head 10 is provided in the −Z-axis direction of the guide rail 32.

The moving mechanism 30 moves the head 10 so that the head 10 and the light reception element 20 face each other as illustrated in FIG. 1, for example. As viewed from the Z-axis direction, the head 10 overlaps with the light reception element 20.

The moving mechanism 30 moves the head 10 to set the state where the head 10 and the recording target object 2 face each other as illustrated in FIG. 2, for example. As viewed from the Z-axis direction, the head 10 overlaps with the recording target object 2. Further, the head 10 overlaps with the support unit 42. Further, as viewed from the Z-axis direction, the head 10 may be positioned between the support unit 42 and the transport unit 40 instead of overlapping with the support unit 42.

For example, the transport unit 40 is provided in the −X-axis direction of the light reception element 20. The transport unit 40 transports the recording target object 2 to the support unit 42. In the example illustrated in the drawing, the transport unit 40 transports the recording target object 2 in the −X-axis direction. The recording target object 2 is wound about the transport unit 40. For example, the transport unit 40 is a roller that supplies the recording target object 2 to the support unit 42. For example, the shape of the recording target object 2 is a sheet-like shape.

For example, the support unit 42 is provided in the −X-axis direction of the transport unit 40. At the time of recording on the recording target object 2, the support unit 42 supports the recording target object 2 transported from the transport unit 40. For example, the support unit 42 is a platen roller. In the example illustrated in the drawing, the transport unit 40 and the support unit 42 rotate about the Y axis as a center. Rotation of the transport unit 40 and the support unit 42 is controlled by the control unit 50, for example.

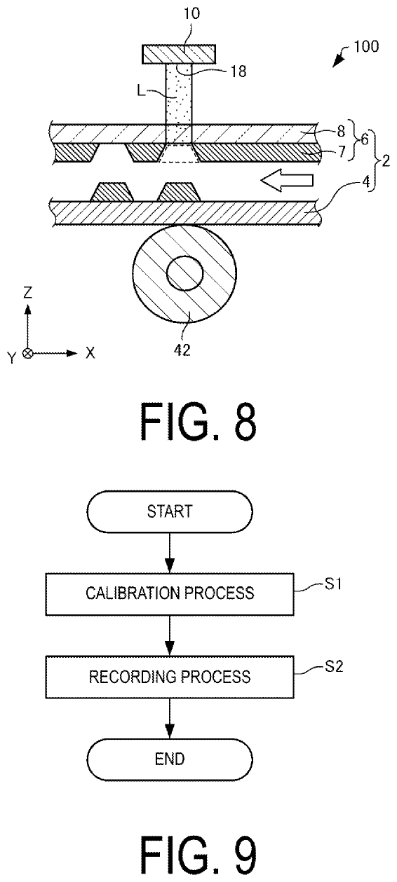

Here, FIG. 8 is a sectional view taken along the line VIII-VIII in FIG. 2, schematically illustrating the recording device 100. At the time of recording on the recording target object 2, the recording target object 2 is positioned between the head 10 and the support unit 42. The recording target object 2 includes a recording sheet 4 and an ink ribbon 6 provided above the recording sheet 4. The ink ribbon 6 includes an ink layer 7 formed of thermo-meltable ink and a base 8 provided on the ink layer 7. For example, the base 8 is transparent. At the time of irradiation with the laser light L from the head 10, the ink layer 7 in the irradiated part is melted and transferred onto the recording sheet 4. In this manner, recording such as printing can be performed on the recording sheet 4. The recording device 100 is a thermal printer of a thermal transfer type, for example. Note that, for the convenience of the description, the recording sheet 4 and the ink ribbon 6 are away from each other in FIG. 8. In general, the recording sheet 4 and the ink ribbon 6 contact with each other.

The control unit 50 is composed of a computer including a processor, a main storage apparatus, and an input/output interface for performing input and output of signals with external parts, for example. The control unit 50 implements various functions with the processor executing the program read in the main storage apparatus, for example. Specifically, the control unit 50 controls the laser element 18, the moving mechanism 30, the transport unit 40, and the support unit 42. Note that the control unit 50 may be composed of a combination of a plurality of circuits, not the computer.

### 1.2 Process of Control Unit

FIG. 9 is a flowchart for describing a process of the control unit 50. A user outputs a process start signal for starting a process to the control unit 50 by operating an operation unit not illustrated in the drawings, for example. The operation unit is composed of a mouse, a keyboard, a touch panel, and the like. When the control unit 50 receives the process start signal, it starts the process.

### 1.2.1. Calibration Process

The control unit 50 executes a calibration process (step S1). In the process, the control unit 50 controls the laser element 18 and the moving mechanism 30 to irradiate the light reception element 20 with the laser light L in a state where the laser element 18 and the light reception element 20 face each other, as illustrated in FIG. 1.

Specifically, the control unit 50 causes the moving mechanism 30 to move the laser element 18 to set the state where the laser element 18 and the light reception element 20 face each other. Next, the control unit 50 causes the laser element 18 to emit the laser light L. The light reception element 20 is irradiated with the laser light L from the laser element 18.

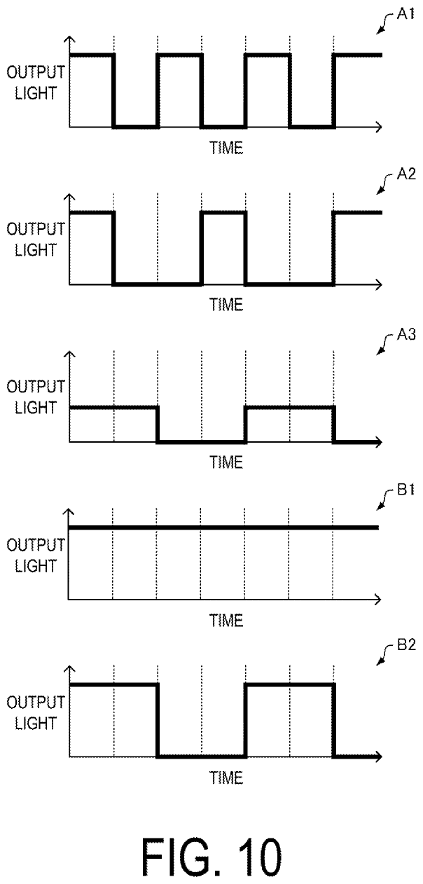

Here, FIG. 10 is a graph illustrating a relationship between a time and a light output at the laser element 18. In FIG. 10, A1, A2 and A3 illustrate relationships in the calibration process. B1 and B2 illustrate relationships in a recording process of performing recording on the recording target object 2.

The control unit 50 pulse-drives the laser element 18 as illustrated in A1 of FIG. 10 in the calibration process, and Continuous-Wave (CW) drives the laser element 18 as illustrated in B1 of FIG. 10 in the recording process, for example. In this manner, damage to the light reception element 20 due to the laser light L can be suppressed. In the example illustrated in the drawing, the light output of the CW-driving is constant.

When the control unit 50 pulse-drives the laser element 18 as illustrated in B2 of FIG. 10 in the recording process, the control unit 50 may pulse-drive the laser element 18 in the calibration process at a frequency higher than the frequency of the pulse-driving of the laser element 18 in the recording process as illustrated in A1 of FIG. 10. In this manner, damage to the light reception element 20 due to the laser light L can be suppressed.

In addition, when the control unit 50 pulse-drives the laser element 18 in the recording process as illustrated in B2 of FIG. 10, the control unit 50 may drive the laser element 18 in the calibration process with a duty ratio smaller than the duty ratio of the laser element 18 in the recording process as illustrated in A2 of FIG. 10. In this manner, damage to the light reception element 20 due to the laser light L can be suppressed.

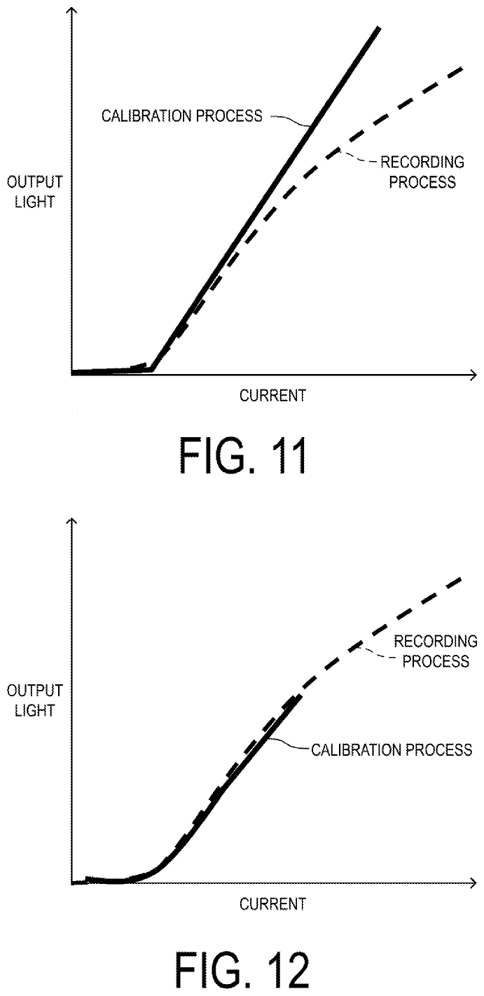

When the laser element 18 is driven as described above, the light output in the calibration process is greater than the light output in the recording process, at a predetermined current value as illustrated in FIG. 11. The reason for this is that, in the recording process, a larger current than that of the calibration process is supplied to the laser element 18, resulting in roll-off of the I-L (injection current-light output) characteristics due to the heat.

Note that FIG. 11 is a graph illustrating a relationship between a supplied current and the light output at the laser element 18. The same applies to FIG. 12 described later.

The control unit 50 determines the injection current into the laser element 18 in the recording process, based on the detection value of the light reception element 20. For example, when the detection value of the light reception element 20 is smaller than a reference value, the control unit 50 sets the injection current into the laser element 18 in the recording process to a value greater than the injection current into the laser element 18 in the calibration process. In this manner, the control unit 50 feeds back the detection value of the light reception element 20 to the recording process. The calibration process is a process for calibrating the light output of the laser light L in the recording process. Note that the reference value is stored in a storage unit, which is omitted in illustration, for example.

As illustrated in A3 of FIG. 10, the control unit 50 may drive the laser element 18 in the calibration process with a light output smaller than the light output of the laser element 18 in the recording process. In this case, as illustrated in FIG. 12, in the calibration process, the current injected to the laser element 18 is small, and thus the light output in the high output region is not directly detected. Thus, the control unit 50 determines the injection current into the laser element 18 in the recording process, based on the light output in the low output region of the calibration process.

Note that, when a plurality of the laser elements 18 are provided, the number of the laser elements 18 into which the current is injected in the calibration process may be smaller than the number of the laser elements 18 into which the current is injected in the recording process. In this manner, damage to the light reception element 20 due to the laser light L can be suppressed.

### 1.2.2. Recording Process

Next, the control unit 50 executes the recording process (step S2). In the process, the control unit 50 controls the laser element 18 and the moving mechanism 30 to irradiate the recording target object 2 with the laser light L, based on the detection value of the light reception element 20, in a state where the laser element 18 and the recording target object 2 face each other, as illustrated in FIG. 2.

Specifically, the control unit 50 causes the moving mechanism 30 to move the laser element 18 to set the state where the laser element 18 and the recording target object 2 face each other. Next, the control unit 50 causes the laser element 18 to emit the laser light L based on the detection value of the light reception element 20. The recording target object 2 is irradiated with the laser light L from the laser element 18. In the recording process, the control unit 50 causes the laser element 18 to emit the laser light L while causing the moving mechanism 30 to move the laser element 18 in the +X-axis direction, based on printing data generated by a user. In this manner, recording can be performed on the recording sheet 4 of the recording target object 2.

Note that description is made above on a case in which the calibration process is executed before the recording process, but the timing of the calibration process is not particularly limited. The calibration process may be executed after the recording process, or may be executed after the recording process is executed for a plurality of times.

### 1.3. Effects

In the recording device 100, the control unit 50 executes the calibration process being a first process. In the process, the control unit 50 controls the laser element 18 and the moving mechanism 30 to irradiate the light reception element 20 with the laser light L in a state where the laser element 18 and the light reception element 20 face each other. Further, the control unit 50 executes the recording process being a second process. In the process, the control unit 50 controls the laser element 18 and the moving mechanism 30 to irradiate the recording target object 2 with the laser light L, based on the detection value of the light reception element 20, in a state where the laser element 18 and the recording target object 2 face each other.

Thus, in the recording device 100, even when the characteristics of the laser element 18 are deviated from the designed value, the deviation can be detected in the calibration process and fed back to the recording process. In this manner, in the recording process, recording can be accurately performed on the recording target object 2.

Further, the recording device 100 irradiates the light reception element 20 with the laser light L in a state where the laser element 18 and the light reception element 20 face each other. Thus, damage to the light path changing element due to the laser light L can be suppressed as compared to a case in which the light path of the laser light L from the laser element to the recording target object is changed by using a light path changing element such as a mirror and a beam splitter to irradiate the light reception element with the laser light L, for example. Therefore, calibration can be safely performed. When the light path changing element is damaged, the laser light L may not possibly be guided to the light reception element. In particular, when the laser element is a PCSEL, the light path changing element is easily damaged because the radiation angle is narrow and the energy density is high.

In the recording device 100, the moving mechanism 30 moves the laser element 18 to change the relative position of the laser element 18 and the recording target object 2 and the relative position of the laser element 18 and the light reception element 20. Thus, in the recording device 100, it is not required to move the light reception element 20.

The recording device 100 includes the support unit 42 that supports the recording target object 2 and the transport unit 40 that transports the recording target object 2 to the support unit 42. Thus, in the recording device 100, the recording target object 2 can be supplied to the support unit 42.

In the recording device 100, the laser element 18 is a surface emitting laser. Thus, in the recording device 100, the laser element 18 can be easily arrayed. In this manner, the recording time on the recording target object 2 can be reduced.

In the recording device 100, the laser element 18 is a PCSEL. Thus, in the recording device 100, the radiation angle of the laser light L is narrow. In this manner, a resolution of recording on the recording target object 2 can be improved.

### 2. Modification Examples of Recording Device

### 2.1. First Modification Example

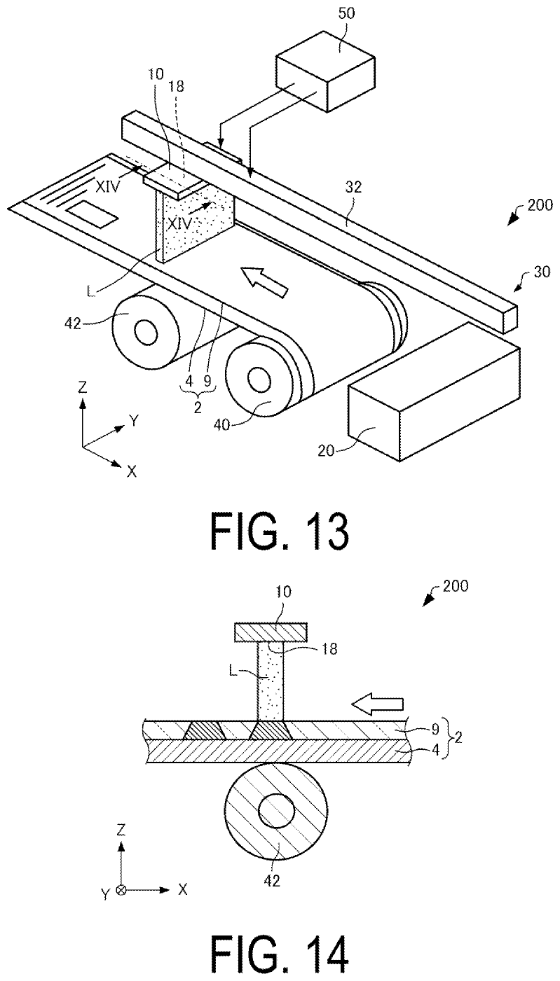

Next, a recording device according to a first modification example of the present embodiment is described with reference to the drawings. FIG. 13 is a perspective view schematically illustrating a recording device 200 according to a first modification of the embodiment. FIG. 14 is a cross-sectional view taken along the line XIV-XIV in FIG. 13, schematically illustrating the recording device 200 according to the first modification example of the embodiment.

Hereinafter, in the recording device 200 according to the first modification example of the present embodiment, members having the same functions as the constituent members of the recording device 100 according to the present embodiment described above are denoted by the same reference numerals, and detailed description thereof is omitted. The same applies to recording devices according to second and third modification examples, which are described later.

The recording device 100 described above is a thermal printer of a thermal transfer type. In contrast, the recording device 200 is an ultraviolet (UV) printer.

As illustrated in FIG. 13 and FIG. 14, in the recording device 200, the recording target object 2 includes the recording sheet 4 and an ink layer 9 provided on the recording sheet 4. The ink layer 9 is formed of UV ink. When the ink layer 9 is irradiated with the laser light L, the ink layer 9 is changed in color and cured. In this manner, recording can be performed on the recording sheet 4.

### 2.2. Second Modification Example

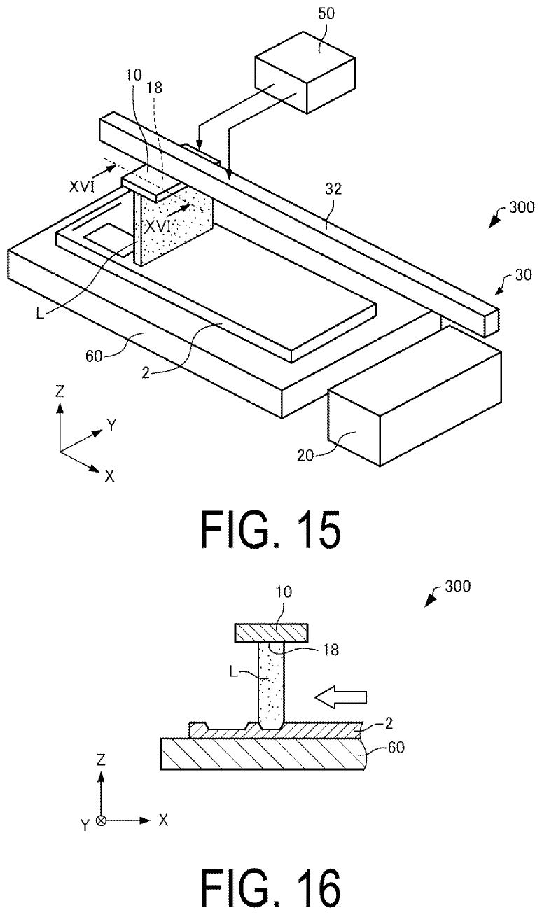

Next, a recording device according to a second modification example of the present embodiment is described with reference to the drawings. FIG. 15 is a perspective view schematically illustrating a recording device 300 according to a second modification example of the present embodiment. FIG. 16 is a cross-sectional view taken along the line XVI-XVI in FIG. 15, schematically illustrating the recording device 300 according to the second modification example of the embodiment.

The recording device 100 described above is a thermal printer of a thermal transfer type. In contrast, the recording device 300 is a laser marker that performs recording on the recording target object 2 through laser marking.

As illustrated in FIG. 15 and FIG. 16, the recording device 300 includes a stage 60. For example, the stage 60 is provided in the −X-axis direction of the light reception element 20. The stage 60 supports the recording target object 2.

The recording target object 2 is provided on the stage 60. For example, the material of the recording target object 2 is metal or a resin. In the recording device 300, recording can be performed on the recording target object 2 by processing the recording target object 2 with the laser light L.

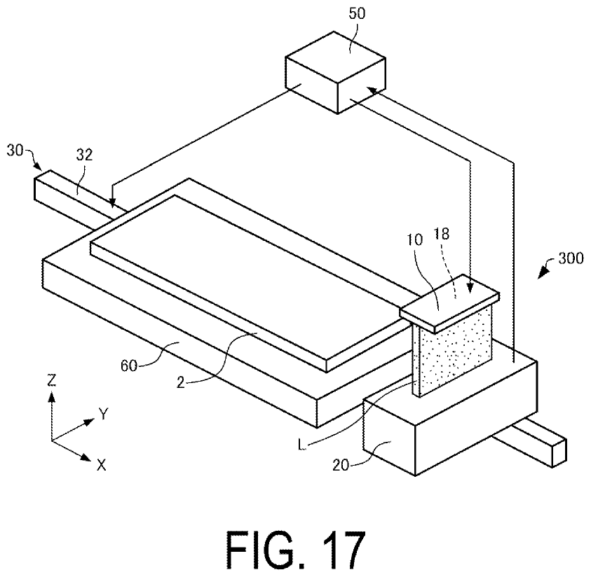

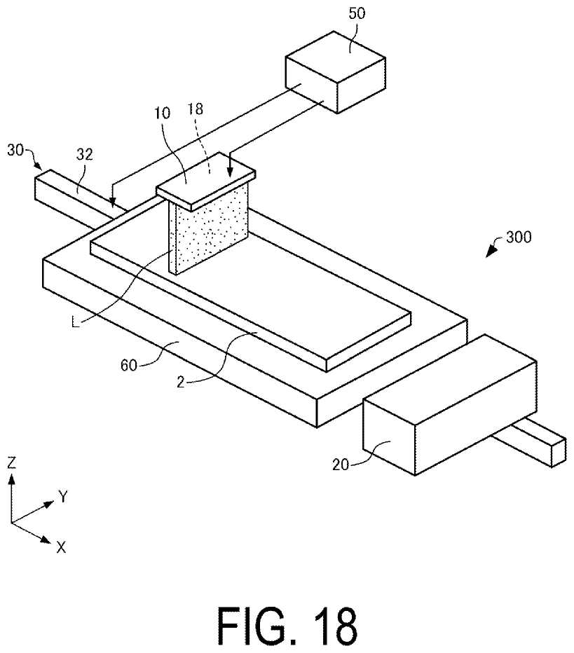

As illustrated in FIG. 17 and FIG. 18, in the recording device 300, the moving mechanism 30 may move the stage 60 and the light reception element 20 to change the relative position of the head 10 and the recording target object 2 and the relative position of the head 10 and the light reception element 20. The guide rail 32 of the moving mechanism 30 is provided in the −Z-axis direction of the light reception element 20 and the stage 60. The light reception element 20 and the stage 60 are supported on the guide rail 32. The light reception element 20 and the stage 60 are supported on the guide rail 32. Note that FIG. 17 illustrates a state where the head 10 and the light reception element 20 face each other. FIG. 18 illustrates a state where the head 10 and the recording target object 2 face each other.

In the recording device 300, the moving mechanism 30 moves the recording target object 2 and the light reception element 20 to change the relative position of the laser element 18 and the recording target object 2 and the relative position of the laser element 18 and the light reception element 20. Thus, in the recording device 300, it is not required to move the laser element 18.

### 2.3. Third Modified Example

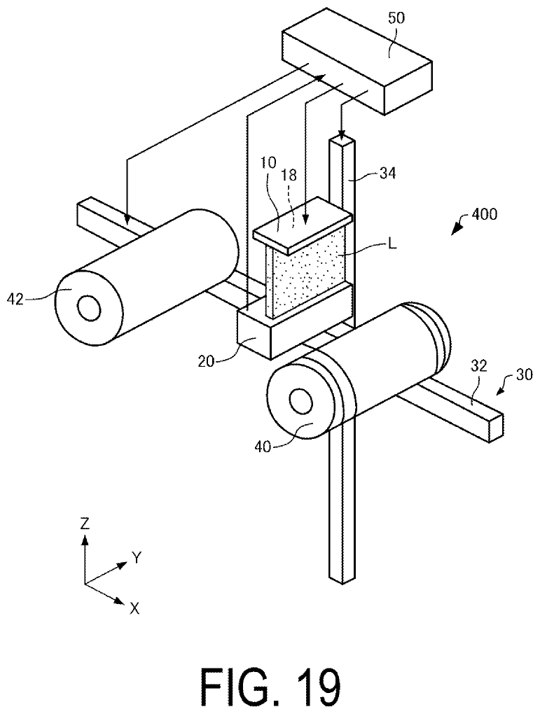

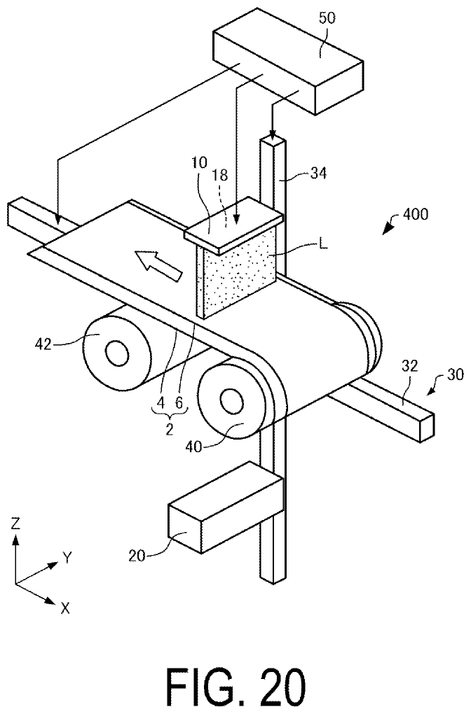

Next, a recording device according to a third modification example of the present embodiment is described with reference to the drawings. FIG. 19 and FIG. 20 are perspective views schematically illustrating a recording device 400 according to the third modification example of the present embodiment. Note that FIG. 19 illustrates a state where the head 10 and the light reception element 20 face each other. FIG. 20 illustrates a state where the head 10 and the recording target object 2 face each other.

As illustrated in FIG. 19 and FIG. 20, the recording device 400 is different from the recording device 100 described above in that the moving mechanism 30 includes a guide rail 34.

The guide rail 34 intersects with the guide rail 32. In the example illustrated in the drawing, the guide rail 34 extends in the Z-axis direction. The transport unit 40 and the support unit 42 are supported on the guide rail 32. The transport unit 40 and the support unit 42 are provided on the guide rail 32. The head 10 and the light reception element 20 are supported on the guide rail 34. The head 10 and the light reception element 20 are provided on the side of the guide rail 34. The moving mechanism 30 moves the support unit 42 in the X-axis direction along the guide rail 32. Further, the moving mechanism 30 moves the light reception element 20 in the Z-axis direction along the guide rail 34. The moving mechanism 30 does not move the head 10.

Note that, as long as the guide rail 32 and the guide rail 34 intersect with each other, the extension direction of the guide rail 34 is not particularly limited. For example, the guide rail 34 may extend the Y-axis direction.

As illustrated in FIG. 19, in the calibration process, the control unit 50 controls the moving mechanism 30 to move the light reception element 20 to position the light reception element 20 between the support unit 42 and the transport unit 40. As a result, the head 10 and the light reception element 20 face each other.

As illustrated in FIG. 20, in the recording process, the control unit 50 controls the moving mechanism 30 to move the light reception element 20 in the −Z-axis direction and move the support unit 42 in the −X-axis direction. As a result, the head 10 and the recording target object 2 face each other.

In the recording device 400, the moving mechanism 30 moves the support unit 42 in the X-axis direction being a first direction, and moves the light reception element 20 in the Z-axis direction being a second direction intersecting the X-axis direction. Thus, for example, in the recording device 400, it is not required to move the laser element 18.

In the recording device 400, in the calibration process, the control unit 50 controls the moving mechanism 30 to position the light reception element 20 between the support unit 42 and the transport unit 40. Thus, in the recording device 400, the calibration process can be executed without moving the laser element 18.

In the recording device 400, the first direction is the horizontal direction, and the second direction is the vertical direction. Thus, for example, the size of the recording device 400 in the horizontal direction can be reduced as compared to a case in which both the first direction and the second direction are the horizontal directions.

The embodiment and modification examples described above are examples, and are not intended as limiting. For example, each embodiment and each modification example can also be combined together as appropriate.

The present disclosure includes configurations that are substantially identical to the configurations described in the embodiment, for example, configurations with identical functions, methods and results, or with identical objects and effects. Also, the present disclosure includes configurations obtained by replacing non-essential portions of the configurations described in the embodiment. In addition, the present disclosure includes configurations having the same operations and effects or can achieve the same objects as the configurations described in the embodiment. Further, the present disclosure includes configurations obtained by adding known techniques to the configurations described in the embodiment.

The following content is derived from the embodiment and the modification examples described above.

An aspect of a recording device includes a laser element configured to emit laser light onto a recording target object, a light reception element configured to receive the laser light from the laser element, a moving mechanism configured to change a relative position of the laser element and the recording target object and a relative position of the laser element and the light reception element, and a control unit configured to control the laser element and the moving mechanism, wherein the control unit performs a first process of controlling the laser element and the moving mechanism to irradiate the light reception element with laser light in a state where the laser element and the light reception element face each other, and a second process of controlling the laser element and the moving mechanism to irradiate the recording target object with laser light based on a detection value of the light reception element in a state where the laser element and the recording target object face each other.

With the recording device, recording can be accurately performed on the recording target object.

In the one aspect of the recording device, the moving mechanism may move the laser element to change the relative position of the laser element and the recording target object and the relative position of the laser element and the light reception element.

With the recording device, it is not required to move the light reception element.

In the one aspect of the recording device, the moving mechanism may move the recording target object and the light reception element to change the relative position of the laser element and the recording target object and the relative position of the laser element and the light reception element.

With the recording device, it is not required to move the laser element.

The one aspect of the recording device may include a support unit configured to support the recording target object and a transport unit configured to transport the recording target object to the support unit.

With the recording device, the recording target object can be supplied to the support unit.

In the one aspect of the recording device, the moving mechanism may move the support unit in a first direction, and may move the light reception element in a second direction intersecting the first direction.

With the recording device, it is not required to move the laser element.

In the one aspect of the recording device, in the first process, the control unit may control the moving mechanism to position the light reception element between the support unit and the transport unit.

With the recording device, the first process can be executed without moving the laser element.

In the one aspect of the recording device, the first direction may be a horizontal direction, and the second direction may be a vertical direction.

With the recording device, the size in the horizontal direction can be reduced.

In the one aspect of the recording device, the laser element may be a surface emitting laser.

With the recording device, the laser element can be easily arrayed.

In the one aspect of the recording device, the laser element may be a photonic crystal surface emitting laser.

With the recording device, the radiation angle of the laser light from the laser element can be reduced.

What is claimed is:

1. A recording device comprising:
a laser element configured to emit laser light;
a light reception element configured to receive the laser light from the laser element;
a moving mechanism configured to change a relative position of the laser element and a recording target object and a relative position of the laser element and the light reception element; and
a control unit configured to control the laser element and the moving mechanism, wherein
the control unit is configured to perform:
a first process of controlling the laser element and the moving mechanism to irradiate the light reception element with laser light in a state where the laser element and the light reception element face each other; and
a second process of controlling the laser element and the moving mechanism to irradiate the recording target object with laser light based on a detection value of the light reception element in a state where the laser element and the recording target object face each other.

2. The recording device according to claim 1, wherein
the moving mechanism moves the laser element to change the relative position of the laser element and the recording target object and the relative position of the laser element and the light reception element.

3. The recording device according to claim 1, wherein
the moving mechanism moves the recording target object and the light reception element to change the relative position of the laser element and the recording target object and the relative position of the laser element and the light reception element.

4. The recording device according to claim 1, further comprising:
a support unit configured to support the recording target object; and
a transport unit configured to transport the recording target object to the support unit.

5. The recording device according to claim 4, wherein
the moving mechanism moves the support unit in a first direction, and moves the light reception element in a second direction intersecting the first direction.

6. The recording device according to claim 5, wherein
in the first process, the control unit controls the moving mechanism to position the light reception element between the support unit and the transport unit.

7. The recording device according to claim 6, wherein
the first direction is a horizontal direction, and
the second direction is a vertical direction.

8. The recording device according to claim 1, wherein
the laser element is a surface emitting laser.

9. The recording device according to claim 8, wherein
the laser element is a photonic crystal surface emitting laser.
